(19) United States
(12) Patent Application Publication
(10) Pub. No.: US 2014/0344053 A1
(43) Pub. Date: Nov. 20, 2014

(54) ELECTRONIC DEVICE AND METHOD FOR MANIPULATING THE SAME

(71) Applicants: Streaming21 International Inc., San Jose, CA (US); Quanta Computer Inc., Tao Yuan Shien (TW)

(72) Inventors: Yung-Wei YANG, Taipei City (TW); Jung-Shen LEE, Hsinchu City (TW); Meng-Jou LIN, New Taipei City (TW); Lung-Wei HUNG, Taichung City (TW)

(73) Assignees: STREAMING21 INTERNATIONAL INC., San Jose, CA (US); QUANTA COMPUTER INC., Tao Yuan Shien (TW)

(21) Appl. No.: 13/971,103

(22) Filed: Aug. 20, 2013

(30) Foreign Application Priority Data
May 15, 2013 (TW) 102117244

(51) Int. Cl. G06F 3/0486; H04L 29/08; G06Q 30/02; G06F 3/0481

(52) U.S. Cl. CPC G06F 3/0486; G06F 3/04817; H04L 67/06; G06Q 30/0255; G06Q 30/0269
USPC 705/14.53; 715/748; 705/14.66

(57) ABSTRACT

An electronic device comprising a processor, a communication module and a touch screen is provided. The communication module and the touch screen are electrically connected to the processor. The touch screen is used for receiving a dragging signal and displaying a user interface. The user interface is used for displaying a hot information area, an application area and a device area on a main page. The device area comprises at least one device icon corresponding to at least one electro-communication device contacting the communication module. When the dragging signal is moving from the hot information area or the application area towards at least one device icon, files of the hot information area or the application area are transmitted to at least one electro-communication device corresponding to at least one device icon of the device area.

This application claims the benefit of Taiwan application Serial No. 102117244, filed May 15, 2013, the subject matter of which is incorporated herein by reference.

### BACKGROUND OF THE INVENTION

1. Field of the Invention

The invention relates in general to an electronic device and method for manipulating the same, and more particularly to an electronic device capable of contacting at least one electro-communication device and a method for manipulating the same.

2. Description of the Related Art

Along with the development of electronic products and network communication, more and more electronic products, such as notebook, tablet PC, smart phone, smart TVs, are equipped with network communication function. Through network, the user can transmit information between different electronic devices.

In response to the market demand, the user interface of electronic devices needs to be more user friendly and more adapted to the user's habit of use.

### SUMMARY OF THE INVENTION

The invention is directed to an electronic device and a method for manipulating the same. The electronic device which contacts at least one electro-communication device, and has a user interface more adapted to the user's habits of use.

According to one embodiment of the present invention, an electronic device comprising a processor, a communication module and a touch screen is provided. The communication module and the touch screen are electrically connected to the processor. The touch screen is used for receiving a dragging signal and displaying a user interface. The user interface is used for displaying a hot information area, an application area and a device area on a main page. The device area comprises at least one device icon corresponding to at least one electro-communication device contacting the communication module. When the dragging signal is moving from the hot information area or the application area towards at least one device icon, files of the hot information area or the application area are transmitted to at least one electro-communication device corresponding to at least one device icon of the device area.

According to another embodiment of the present invention, a method for manipulating an electronic device is provided. The method comprises following steps. An electronic device comprising a processor, a communication module and a touch screen is provided, wherein the communication module and the touch screen are electrically connected to the processor. A user interface is displayed on the touch screen for displaying a hot information area, an application area and a device area on a main page. The device area comprises at least one device icon corresponding to at least one electro-communication device contacting the communication module. The touch screen receives a dragging signal. When the dragging signal is moving from the hot information area or the application area towards at least one device icon, files of the hot information area or the application area are transmitted to at least one electro-communication device corresponding to at least one device icon of the device area.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 shows a schematic diagram of an electronic device according to an embodiment of the invention.

FIG. 2 shows a schematic diagram of a method of receiving hot information by a hot information area of an electronic device according to an embodiment of the invention.

FIG. 3 shows a schematic diagram of the display modes of a device area of an electronic device according to an embodiment of the invention.

FIG. 4 shows a system architecture diagram of device link within a private domain according to an embodiment of the invention.

FIG. 5 shows a schematic diagram of the relationship between a user and an electronic device within a private domain according to an embodiment of the invention.

FIG. 6A shows a flowchart of a method of adding a user to a database by an administrator of an electronic device according to an embodiment of the invention.

FIG. 6B shows a flowchart of a method of editing a user to a database by an administrator of an electronic device according to an embodiment of the invention.

FIG. 6C shows a flowchart of a method of deleting a user to a database by an administrator of an electronic device according to an embodiment of the invention.

FIG. 7 shows a schematic diagram of a sharing area according to an embodiment of the invention.

FIG. 8 shows a schematic diagram of a visitor device displayed on a device area according to an embodiment of the invention.

FIG. 9 shows a schematic diagram of a newly added device displayed on a device area according to an embodiment of the invention.

FIG. 10A shows a flowchart of locating a newly added device and creating a corresponding visitor icon according to an embodiment of the invention.

FIG. 10B shows a flowchart of adding the visitor device as a newly added electro-communication device according to an embodiment of the invention.

FIG. 11 shows a flowchart of transmitting and receiving request and data between the devices in a group according to an embodiment of the invention.

FIGS. 12˜13 are processes of a method of exchanging messages between devices according to an embodiment of the invention.

FIG. 14 shows a flowchart of method of exchanging messages between devices according to an embodiment of the invention.

FIG. 15 shows a flowchart of transmitting messages between a device and a server according to an embodiment of the invention.

FIG. 16 shows a flowchart of transmitting messages between a device and a server according to another embodiment of the invention.

FIG. 17 shows a flowchart of transmitting messages between a device and a server according to an alternate embodiment of the invention.

### DETAILED DESCRIPTION OF THE INVENTION

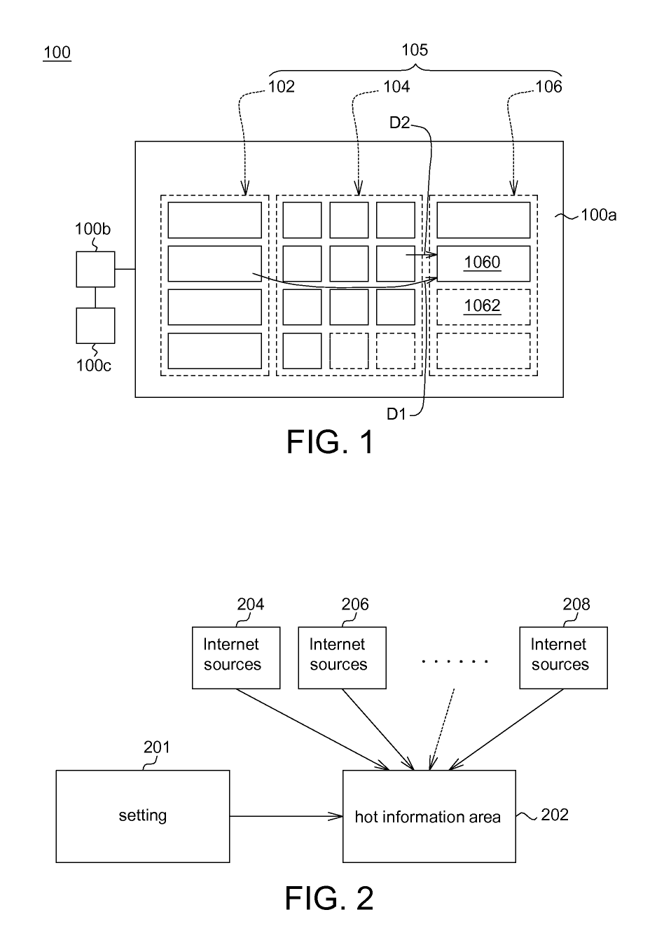

Referring to FIG. 1, a schematic diagram of an electronic device according to an embodiment of the invention is shown. As indicated in FIG. 1, the electronic device 100 comprises a touch screen 100a, a processor 100b and a communication module 100c. The communication module 100c and the touch screen 100a are electrically connected to the processor 100b.

The touch screen 100a is used for receiving a dragging signal D1 or a dragging signal D2 and displaying a user interface 105. The user interface 105 is used for displaying a hot information area 102, an application area 104 and a device area 106 on a main page, such as a home page of the electronic device 100. The device area 106 comprises at least one device icon 1060 corresponding to at least one electro-communication device (not illustrated) contacting the communication module 100c.

The hot information area 102 displays the hot information received from the clouds or the Internet source. Examples of the hot information include date, time, weather, stock information, news, traffic profile, calendar, reminder, game score and advertisement.

The application area 104 can display programs to be executed, such as a built-in or purchased pending program. The software can be divided into personal clouds exclusive software, built-in operating system platform software and software downloaded from software shops. The personal clouds exclusive software can be labeled with a specific mark, such as a personal exclusive mark, on the left top corner of the frame (not illustrated). Each frame of the installed software can be instantaneously displayed on the application area 104. Once new software or application is installed or added, the live status of the newly installed or added software or application can be displayed on the application area 104. The display sequence of the software or application may be based on the user's frequency of use.

In an embodiment, when the dragging signal D1 is moving from a hot information area 102 towards at least one device icon 1060 or when the dragging signal D2 is moving from an application area 104 towards at least one device icon 1060, files of the hot information area 102 or the application area 104 are transmitted to at least one electro-communication device corresponding to at least one device icon 1060 of the device area 106.

In an embodiment, the hot information area 102, the application area 104 and the device area 106 can display with different colors and/or sizes of frames. Thus, the user can clearly differentiate the hot information area 102, the application area 104 and the device area 106 according to different colors.

In an embodiment, the size of the frame is positively correlated with the capacity of the stored information. Thus, the user can determine the capacity of the information stored in the frame according to the size of the frame. Respective frame of the hot information area 102, the application area 104 and the device area 106 can be designed according to the user experience.

As indicated in FIG. 1, the at least one electro-communication device corresponding to the at least one device icon 1060 may be, for example, an authenticated device. Moreover, the device area 106 further comprises at least one visitor icon 1062 corresponding to at least one visitor device (not illustrated) contacting the communication module 100c. The communication module 100c of the electronic device 100 and the at least one electro-communication device and/or at least one visitor device are located in the same domain. The authenticated electro-communication devices and the visitor devices may be realized by any electronic products having network communication function such as but not limited to mobile phone, TV, fridge, Tablet PC or digital camera.

In an embodiment, the borders of the at least one visitor icon 1062 are different from that of at least one device icon 1060, but the invention is not limited thereto. In other embodiments, the at least one visitor icon 1062 (corresponding to non-authenticated device) and at least one device icon 1060 (corresponding to authenticated device) can have different colors, sizes, shadings or shapes by which the authenticated device and the non-authenticated visitor device can be differentiated.

Referring to FIG. 2, a schematic diagram of a method of receiving hot information by a hot information area of an electronic device according to an embodiment of the invention is shown. In the present embodiment, the hot information area 202 can receive the latest hot information from the Internet sources 204, 206 and 208, such as the clouds, according to the conditions of the default or user defined setting 201. Since the data of the hot information area 202 of each synchronized device is updated periodically, the hot information can be continuously updated to assure that the data of the hot information area 202 is the latest.

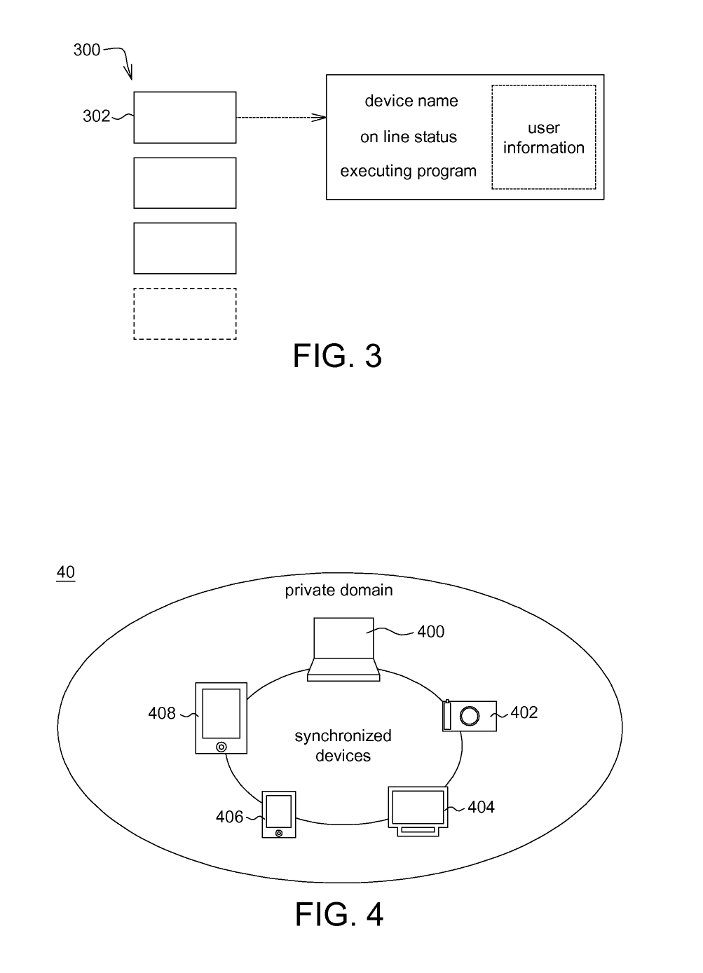

Referring to FIG. 3, a schematic diagram of the display modes of a device area of an electronic device according to an embodiment of the invention is shown. In an embodiment as indicated in FIG. 3, all synchronized devices in the device area 300 belong to the same group, and each is represented by an individual frame. That is, each frame represents a synchronized device and its hot information. The device area 300 can display one or more than one device processed in a synchronous manner. For example, the device area 300 can display all synchronized devices and their live status. When the user clicks one of the devices 302, its hot information, such as the device name, on-line status, executing programs, and user information (such as user photo), will be displayed on the user interface.

FIG. 4 shows a system architecture diagram of device link within a private domain according to an embodiment of the invention. Under the system architecture 40, the electronic devices 400, 402, 404, 406 and 408 have mutual contact, and can view each other and share information within the private domain in a synchronous manner. For example, the electronic devices 400, 402, 404, 406 and 408 belonging to the members of the same family (such as father, mother and children) can have synchronous contact within the domain and share medium information.

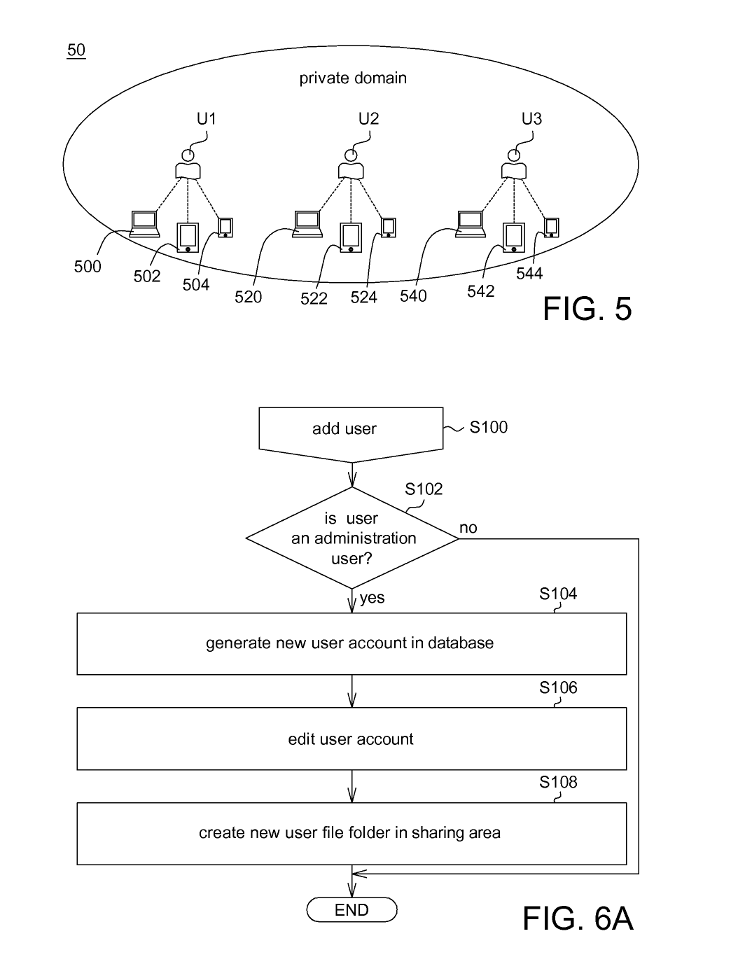

FIG. 5 shows a schematic diagram of the relationship between a user and an electronic device within a private domain according to an embodiment of the invention. As indicated in FIG. 5, each member (user) within a private domain can have more than one electronic device. For example, the user U1 can have electronic devices 500, 504 and 506; the user U2 can have electronic devices 520, 524 and 526; the user U3 can have electronic devices 540, 544 and 546. The number of electronic devices each member can have is not subjected to any restriction.

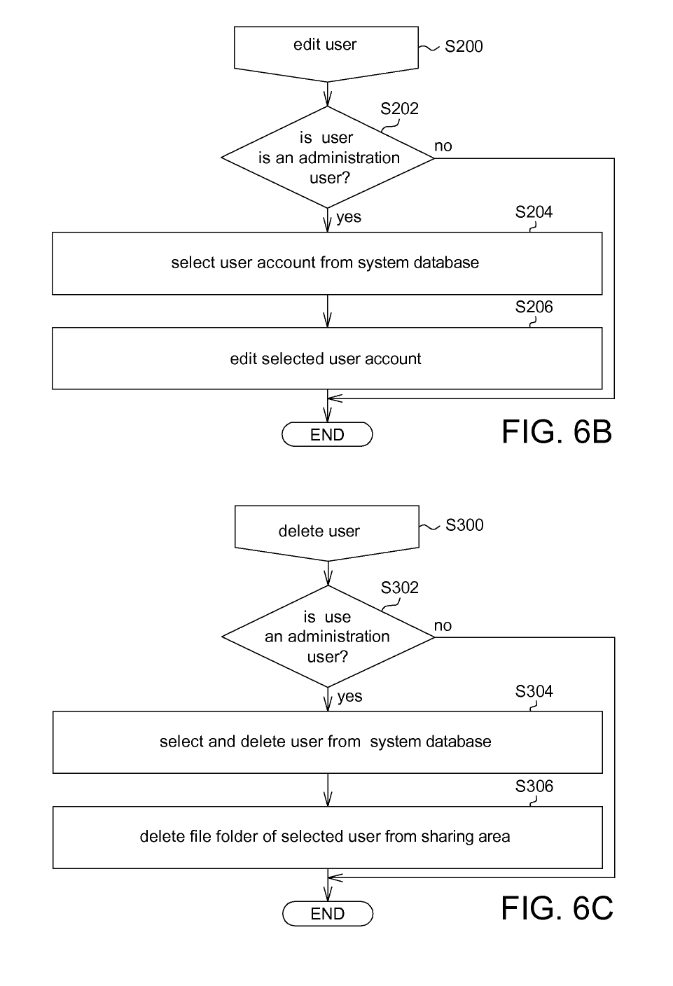

FIGS. 6A-6C are flowcharts of a method of adding, editing and deleting a user to a database by an administrator of an electronic device according to an embodiment of the invention. Referring to FIG. 6A, a flowchart of a method of adding a user to a database by an administrator of an electronic device according to an embodiment of the invention is shown. In step S100, the step of adding a user is executed. In step S102, whether the user is an administration user is determined. If it is determined that the user is an administration user, then the method proceeds to S104. In step S104, a new user account is generated in the database. In step S106, the user account is edited. In step S108, the method terminates after a new user file folder is created in the sharing area. In step S102, the method terminates directly if it is determined that the user is not an administration user.

FIG. 6B shows a flowchart of a method of editing a user to a database by an administrator of an electronic device according to an embodiment of the invention. In step S200, the step of editing a user is executed. In step S202, whether the user is an administration user is determined. If it is determined that the user is an administration user, then the method proceeds to S204. In step S204, a user account is selected for editing from a system database. In step S206, the method terminates after the selected user account is edited. In step S202, the method terminates directly if it is determined that the user is not the administration user.

FIG. 6C shows a flowchart of a method of deleting a user to a database by an administrator of an electronic device according to an embodiment of the invention. In step S300, the step of deleting a user is executed. In step S302, whether the user is an administration user is determined. If it is determined that the user is an administration user, then the method proceeds to S304. In step S304, a user account is selected for deleting from the system database, and the user account is deleted from the system database. In step S306, the method terminates after the file folder of the selected user account is deleted from the sharing area. In step S302, the method terminates directly if it is determined that the user is not the administration user.

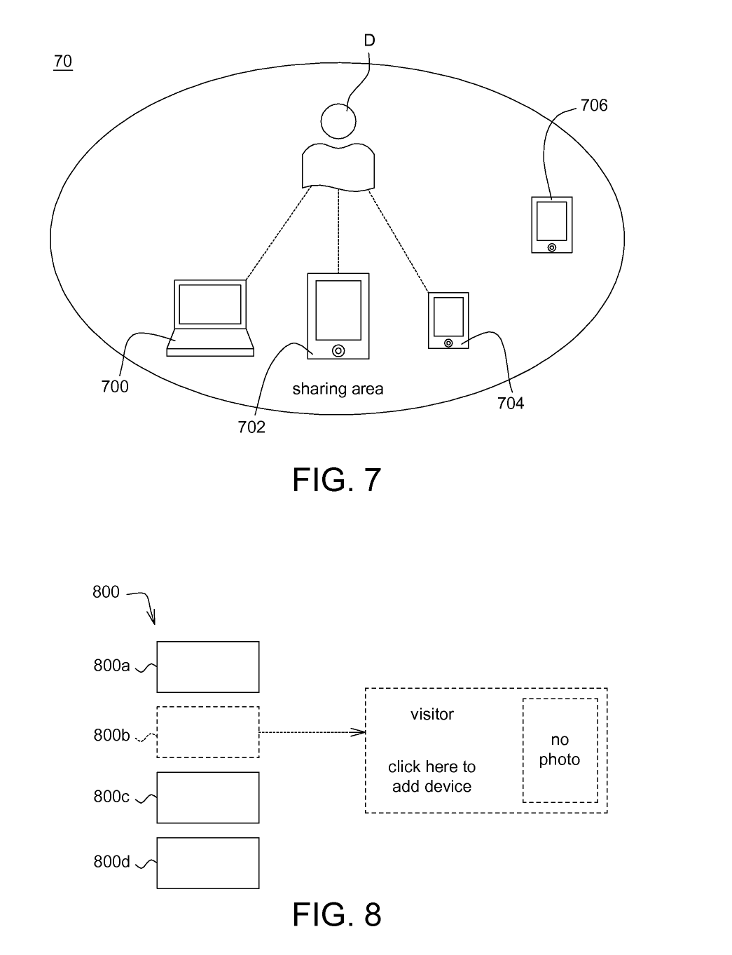

FIG. 7 shows a schematic diagram of a sharing area according to an embodiment of the invention. As indicated in FIG. 7, the user D can have electronic devices 700, 702 and 704 in a sharing area 70. The electronic devices 700, 702 and 704 in the sharing area 70 are processed in a synchronous manner. The electronic devices 700, 702 and 704 synchronously update photos and status, and allow the users to view each other on the device area (illustrated in FIG. 1). When a newly added electronic device 706 enters the coverage of the network of the sharing area 70 and executes a synchronization program, the newly added electronic device 706 is regarded as a visitor device. However, the newly added electronic device 706 cannot synchronize with other electronic devices in the sharing area 70. Until the association between the newly added electronic device 706 and the user D is created the newly added electronic device 706 will be able to join the sharing area 70 and synchronize with the electronic devices 700, 702 and 704.

FIG. 8 shows a schematic diagram of a visitor device displayed on a device area according to an embodiment of the invention. Referring to FIG. 8, the device area 800 comprises authenticated electro-communication devices 800a, 800c and 800d, and a non-authenticated visitor device 800b. The authenticated electro-communication devices 800a, 800c and 800d and the non-authenticated visitor device 800b can have different borders, shading, color, shape or size by which the authenticated devices and the non-authenticated devices are differentiated, and only the authenticated devices have the authority for synchronous sharing.

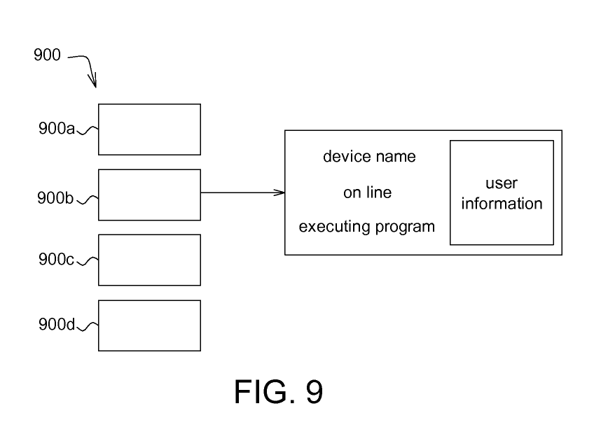

FIG. 9 shows a schematic diagram of a newly added device displayed on a device area according to an embodiment of the invention. Referring to FIG. 9, the device area 900 comprises authenticated electro-communication devices 900a, 900c and 900d, and comprises newly added electro-communication device 900b. Once the association between the newly added electro-communication device 900b and the user is created, the frame of the newly added electro-communication device 900b will be the same as that of the authenticated electro-communication devices 900a, 900c and 900d to indicate that the authenticated electro-communication devices 900a, 900c and 900d and the newly authenticated electro-communication device 900b have the same authority and synchronous processing. The association between the newly added electro-communication device 900b and the existing user can be created by the administration user or can be created by the user by way of password authentication or key authentication.

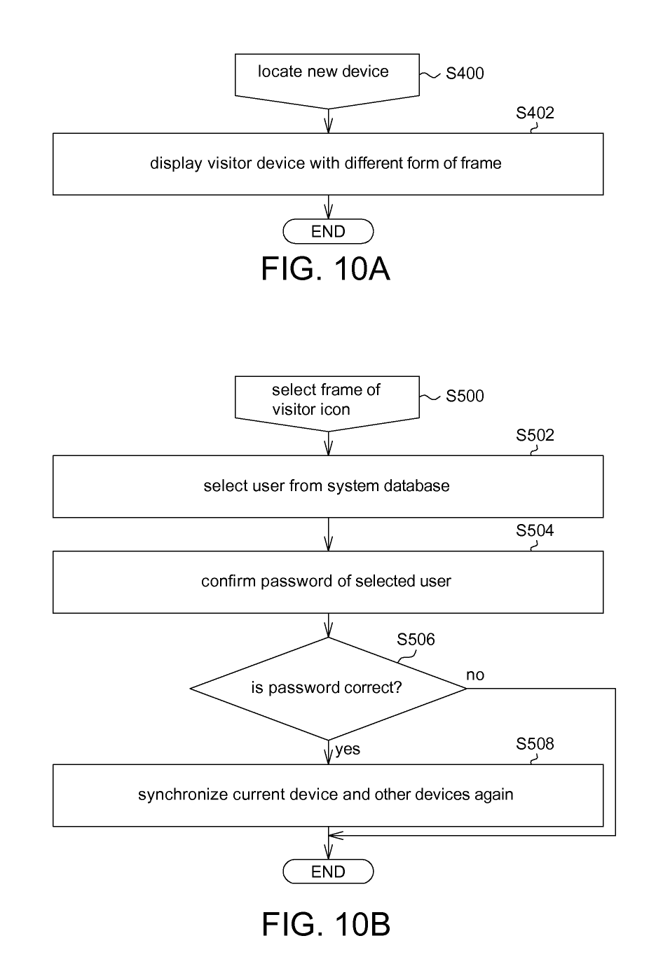

FIG. 10A shows a flowchart of locating a newly added device and creating a corresponding visitor icon according to an embodiment of the invention. In step S400, a newly added device is located in the domain. In step S402, the method terminates after a corresponding visitor icon of a visitor device is represented with different form of frame and displayed on the device area.

FIG. 10B shows a flowchart of adding the visitor device as a newly added electro-communication device according to an embodiment of the invention. In step S500, a visitor frame of a visitor icon is selected. In step S502, a user is selected from a system database. In step S504, a password of the selected user is confirmed. In step S506, whether the password is correct is determined. If it is determined that the password is correct, then the method proceeds to S508, the method terminates after the current device and other devices are synchronized again. Conversely, in step S506, the method terminates directly if it is determined that the password is incorrect.

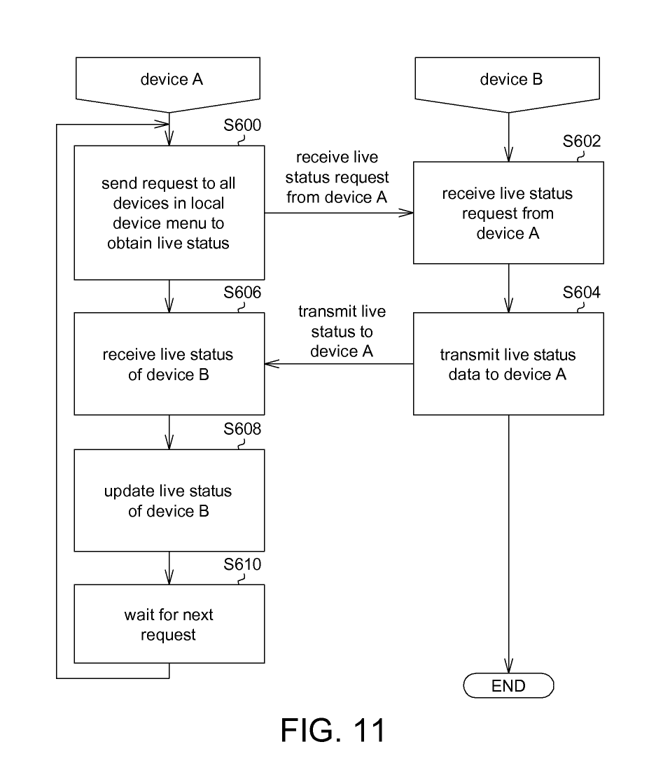

FIG. 11 shows a flowchart of transmitting and receiving request and data between devices A and B in a group according to an embodiment of the invention. In step S600, the device A sends requests to all devices (exemplified by device B) in a local device menu to obtain the live status. In step S602, the device B receives a live status request from the device A. In step S604, the device B transmits live status to the device A. In step S606, the device A receives the live status of the device B. In step S608, the device A updates the live status of the device B displayed on the device area of the device A. In step 610, the device A waits for the next request and proceeds to steps S600.

In an embodiment, when a device is connected to a local network (such as a private domain), the device will execute a registration procedure to become a group member. The devices of the group execute processing in a synchronous manner. That is, when a device joins a group in a local network, the device can be updated to the group list. Moreover, according to the operation status of each device joining the group, the live status of the device can be dynamically updated and exchanged to achieve the handshaking effect.

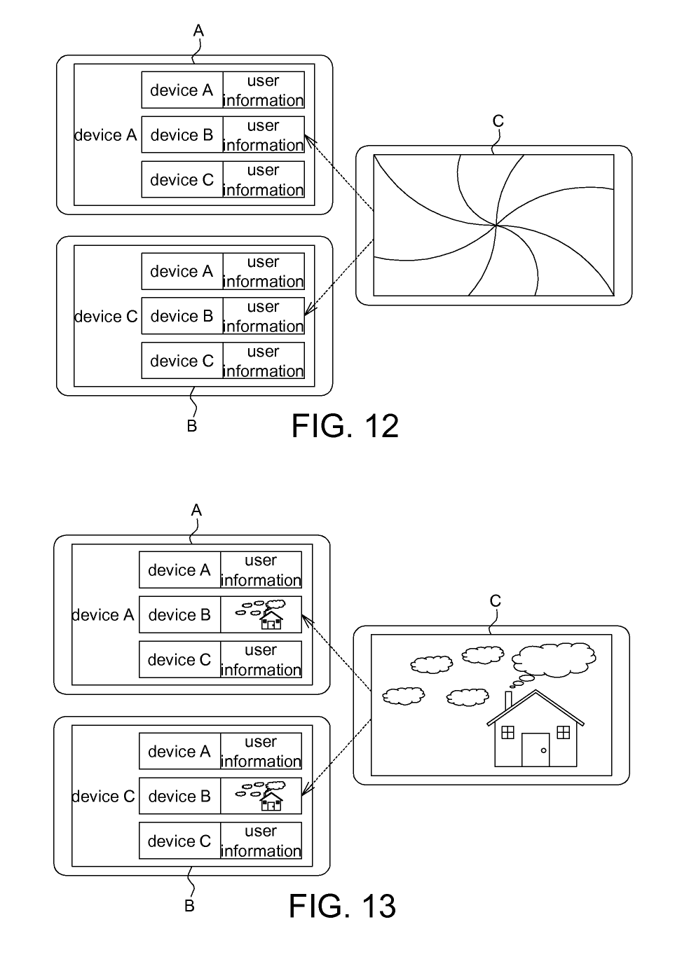

FIGS. 12˜13 are processes of a method of exchanging messages between devices according to an embodiment of the invention. As indicated in the embodiment of FIG. 12, the group has synchronized devices A, B and C. The device B activates a program (such as photographic program). Meanwhile, the corresponding block of the device B displayed on the devices A and C will synchronously update the live status of the device B as the status of activating a program (such as a photographic program).

As indicated in FIG. 13, after the device B fetches an image by using a photographic program, the devices A and C will synchronously update the live status of the device B. For example, the image fetched by the device B is correspondingly displayed on the screens of the devices A and C. In an embodiment, the users of the devices A and C can click the device B on the screen to view the image fetched by the device B. In an embodiment, the device B can select whether to share the fetched image with other synchronized devices (such as device A). Thus, privacy can be suitably protected.

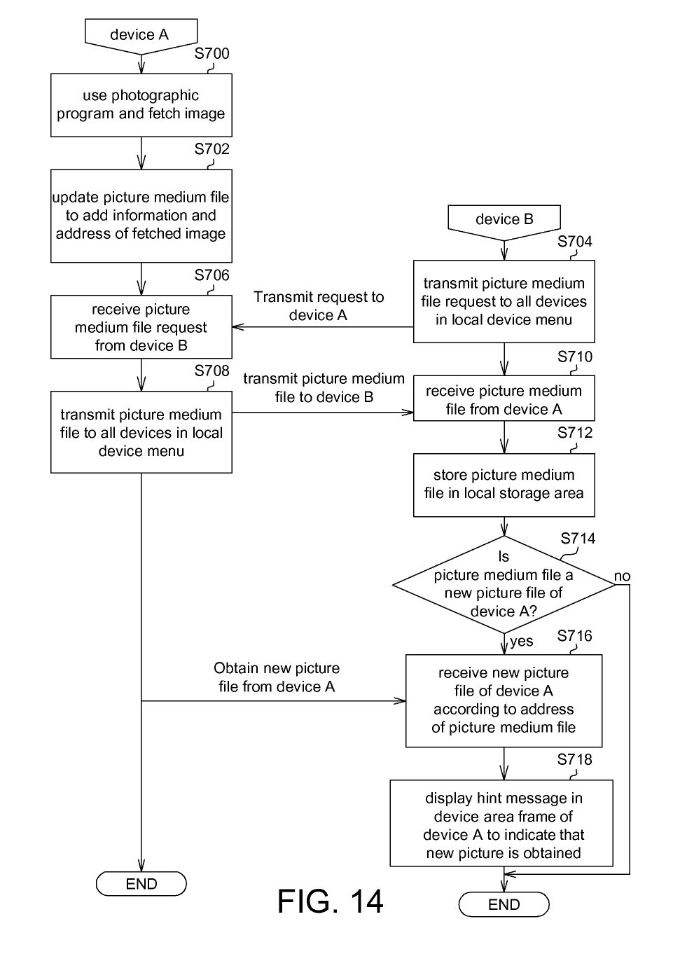

FIG. 14 shows a flowchart of method of exchanging messages between devices according to an embodiment of the invention. FIG. 14, for convenience of elaboration, group synchronization is exemplified by the devices A and B. In step S700, the device A activates a photographic program and fetches an image. In step S702, the device A updates a picture medium file and adds the information and address of the fetched image. In step S704, the device B transmits a picture medium file request to all devices (exemplified by device A) in a local device menu. In step S706, the device A receives a picture medium file request from the device B. In step S708, the device A transmits the picture medium file to all devices in the local device menu. In step S710, the device B receives a picture medium file from the device A.

In step S712, the device B stores the picture medium file in a local storage area (such as the clouds in a private domain). In step S714, the device B determines whether the picture medium file is a new picture file of the device A. If it is determined that the picture medium file is a new picture file, then the method proceeds to step S716. In step S716, the device B receives the new picture file of the device A according to the address of the picture medium file. Then, the method proceeds to step S718, a hint message is displayed in the device area frame of the device A to indicate that the new picture is obtained. In step S714, the method terminates if it is determined that the picture medium file is not the new picture file of the device A.

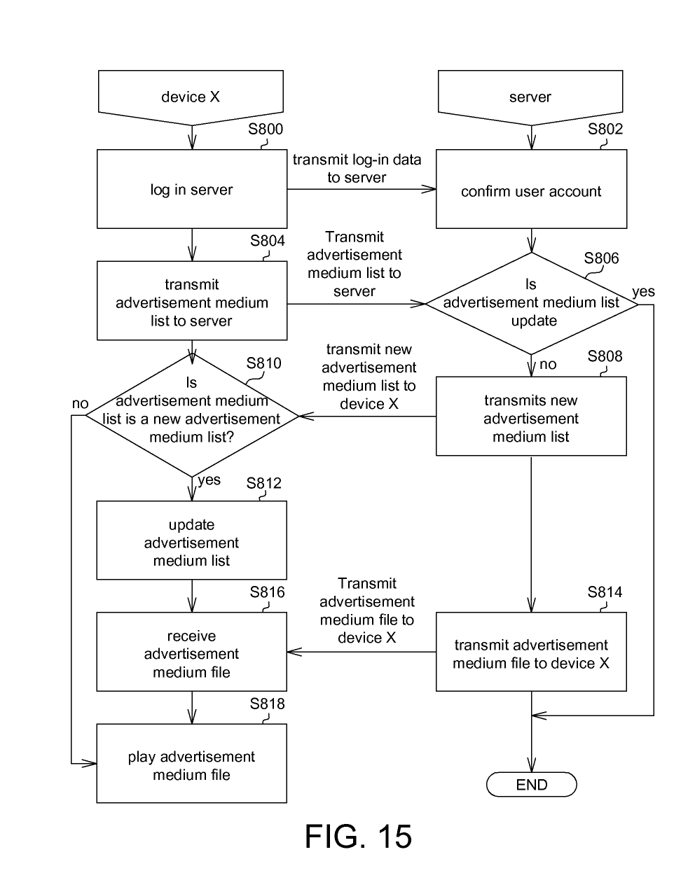

FIG. 15 shows a flowchart of transmitting messages between a device and a server according to an embodiment of the invention. In the embodiment of FIG. 15, when the device is booted, or logged in server the advertisement medium is automatically updated. In step S800, the device X logs in the server, and transmits the log-in data to the server. In step S802, the server confirms the user account of the device X. In step S804, the device X transmits the advertisement medium list to the server. In step S806, the server determines whether the advertisement medium list of the device X is updated. If the received advertisement medium list of the device X is updated, the method terminates.

In step S806, whether the advertisement medium list of the device X is updated is determined after the server receives the advertisement medium list from the server. If it is determined that the advertisement medium list of the device X is not updated, then the method proceeds to step S808. In step S808, the server transmits a new advertisement medium list to the device X. In step S810, whether the advertisement medium list is a new advertisement medium list to the device X is determined after the device X receives the advertisement medium list from the server. If it is determined that the advertisement medium list is not a new advertisement medium list to the device X, then the method directly proceeds to step S818 without updating the advertisement medium list. In step S818, the advertisement medium file is played. If it is determined that the advertisement medium list is a new advertisement medium list to the device X, then the method proceeds to step S812. In step S812, the device X updates the advertisement medium list. In step S814, the server transmits the advertisement medium file to the device X. In step S816, the device X receives the advertisement medium file from the server. Then, then the method proceeds to step S818. In step S818, the device X plays the received advertisement medium file.

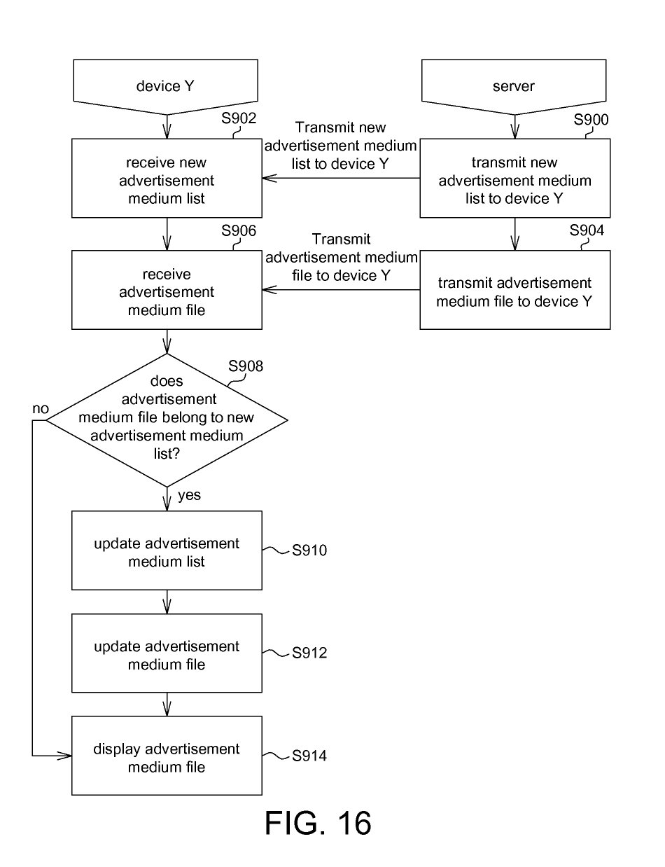

FIG. 16 shows a flowchart of transmitting messages between a device and a server according to another embodiment of the invention. In the embodiment of FIG. 16, the server actively executes the updating step of the advertisement medium. In step S900, the server transmits a new advertisement medium list to the device Y. In step S902, the device Y receives the new advertisement medium list provided by the server. In step S904, the server transmits an advertisement medium file to the device Y. In step S906, the device Y receives the advertisement medium file provided by the server.

In step S908, the device Y determines whether the received advertisement medium file belongs to the new advertisement medium list. If the received advertisement medium file belongs to the new advertisement medium list, then the method proceeds to S910. In step S910, the device Y updates the advertisement medium list. Then, the method proceeds to step S912. In step S912, the device Y updates the advertisement medium file. Then, the method proceeds to step S914. In step S914, the device Y displays the updated advertisement medium file. In step S908, if it is determined that the received advertisement medium file does not belong to the new advertisement medium list, then the method proceeds to step S914 directly. In step S914, the current advertisement medium file is displayed.

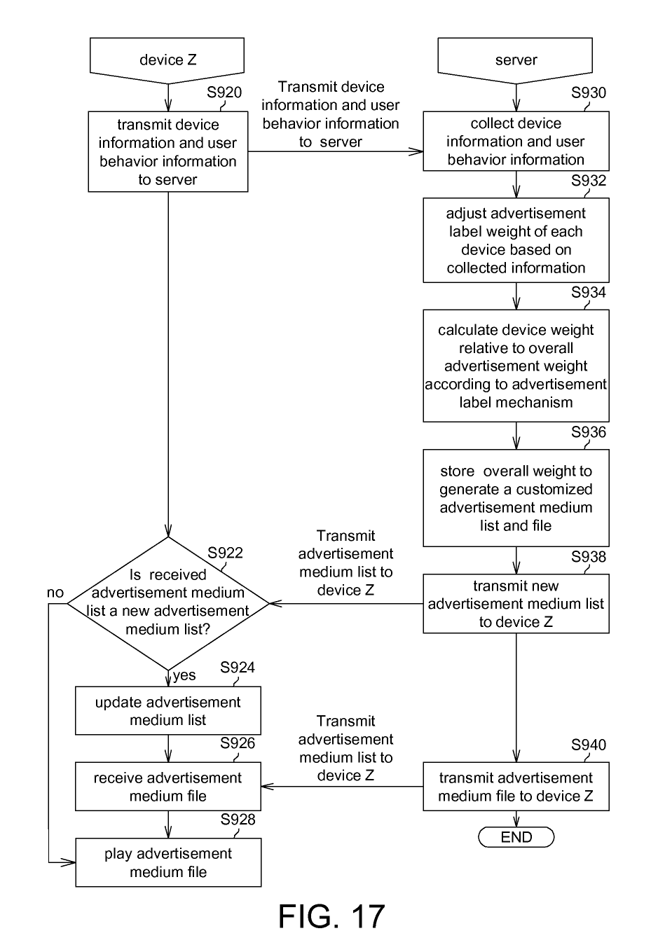

FIG. 17 shows a flowchart of transmitting messages between a device and a server according to an alternate embodiment of the invention. In the embodiment of FIG. 17, a customized advertisement medium is provided to each device according to user experience. In step S920, the device Z transmits device information and user behavior information to the server. In step S930, the server collects the device information and the user behavior information. In step S932, the server adjusts the advertisement label weight of each device (only device Z is exemplified in FIG. 17) based on the collected information. In step S934, the server calculates the device weight relative to the overall advertisement weight according to the advertisement label mechanism. In step S936, the server stores the overall weight to generate a customized advertisement medium list and file. In step S938, the server transmits a new advertisement medium list to the device Z.

In step S922, the device Z, after receiving the new advertisement medium list from the server, determines whether the received advertisement medium list a new advertisement medium list to the device Z. If so, then the method proceeds to S924. In step S924, the device Z updates the advertisement medium list. In step S940, the server transmits an advertisement medium file to the device Z. In step S926, the device receives an advertisement medium file from the server. In step S928, the device Z plays the advertisement medium file. In step S922, if it is determined that the new advertisement medium list transmitted from the server and received by the device Z already stored by the device Z, then the current advertisement medium file is directly played.

The weight calculation of advertisement label is disclosed below. Table 1 illustrates the label weights of advertisements 1, 2 and 3 defined according to the brand, the device and the frequency of use. In Table 1, it is assumed that the advertisement medium file can be divided into three types according to the product brand, the device (facilities and equipment) and the frequency of use.

TABLE 1

| | Weight Label | | |
|---|---|---|---|
| | | | Frequency-of-Use |
| | Brand Weight | Device Weight | Weight |
| Advertisement 1 | A1 | B1 | C1 |
| Advertisement 2 | A2 | B2 | C2 |
| Advertisement 3 | A3 | B3 | C3 |
| . . . | . . . | . . . | . . . |

As illustrated in Table 2, the server can adjust the weight of the advertisement medium file of each device according to the collected user behavior of each device, such as the interaction between users and advertisements.

TABLE 2

| | Label Weight | | |
|---|---|---|---|
| | Brand Weight | Device Weight | Frequency-of-Use Weight |
| Device 1 | X1 | Y1 | Z1 |
| Device 2 | X2 | Y2 | Z2 |
| Device 3 | X3 | Y3 | Z3 |
| . . . | . . . | . . . | . . . |

Based on Table 1 and Table 2, the overall weight of each device and its corresponding customized advertisement label are illustrated in Table 3. The overall weight can be obtained by summing up the products of label weight and advertisement weight for each device, and can be expressed as: An*Xm+Bn*Ym+Cn*Zm. Each label parameter is an integer greater than or equal to 0. The system can adjust label parameters according to actual needs and determine the playing result of advertisement medium. Once the weight corresponding to a particular device changes, the server will generate a new advertisement medium list based on the new weights.

TABLE 3

| | Overall Weight | | |
|---|---|---|---|
| | Device | Device 2 | . . . |
| Advertisement | A1 * X1 + B1 * | A1 * X2 + B1 * Y2 + C1 * Z2 | . . . |
| 1 | Y1 + C1 * Z1 | | |
| Advertisement | A2 * X1 + B2 * | A2 * X2 + B2 * Y2 + C2 * Z2 | . . . |
| 2 | Y1 + C2 * Z1 | | |
| Advertisement | A3 * X1 + B3 * | A3 * X3 + B3 * Y3 + C3 * Z3 | . . . |
| 3 | Y1 + C3 * Z1 | | |
| . . . | . . . | . . . | . . . |

To summarize, the electronic device disclosed in the above embodiments of the invention can contact at least one electro-communication device, and has a user interface more adapted to user's habits of use, such that the user can share hot information or application with at least one electro-communication device on a main page. By using a manipulating method disclosed in an embodiment of the invention, the device status displayed on the sharing area can be managed by adding, editing or deleting synchronized devices. In an embodiment, the electronic device and other electro-communication devices in a private domain can mutually share files or activated programs, and can update the live status in a synchronous manner. In another embodiment, messages such as the update of advertisement medium list and files can be exchanged between the device and the server. In an embodiment, the device can receive the latest advertisement medium file from the server in a proactive or passive manner, and also can determine which advertisement medium file is played according to the weight calculation based on user experience or other parameters.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An method for manipulating an electronic device comprising:
providing an electronic device comprising a processor, a communication module and a touch screen, wherein the communication module and the touch screen are electrically connected to the processor;
displaying a user interface on the touch screen for displaying a hot information area, an application area and a device area on a main page, wherein the device area comprises at least one device icon corresponding to at least one electro-communication device contacting the communication module; and
receiving a dragging signal by the touch screen, wherein when the dragging signal is moving from a hot information area or an application area towards the at least one device icon, files of the hot information area or the application area are transmitted to the at least one electro-communication device corresponding to the at least one device icon of the device area.

2. The method for manipulating an electronic device according to claim 1, wherein the hot information area, the application area and the device area are displayed in different colors and/or sizes of frames, and the size of the frame is associated with an information capacity stored in the frame.

3. The method for manipulating an electronic device according to claim 1, wherein when the electronic device is a management device, the management device further comprises steps of adding, editing and deleting a user, and the electronic device and the user device are located in the same domain,
in the step of adding the user, a user account is generated and edited in a database, and a file folder is created in a sharing area of the domain,
in the step of editing the user, the user account is selected from the database, and the selected user account is edited,
in the step of deleting the user, the user account is selected and deleted from the database, and the user's file folder is deleted from the sharing area of the domain.

4. The method for manipulating an electronic device according to claim 1, wherein the at least one electro-communication device is a plurality of authenticated devices, and the method further comprises:
searching for at least one visitor device and correspondingly displaying at least one visitor icon on the device area, wherein, the at least one visitor device and the authenticated device and the electronic device are located in the same domain, and the color, size, borders, shading or shape of the at least one visitor icon are different from that of the device icon.

5. The method for manipulating an electronic device according to claim 4, further comprising:
receiving a selection signal from the at least one visitor device;
receiving a password outputted from the visitor device; and
determining whether the password is correct: if the password is correct, creating synchronous contact between the visitor device and the electronic device and changing the status of the visitor device to an authenticated status.

6. The method for manipulating an electronic device according to claim 1, wherein the at least one electro-communication device comprises a plurality of electro-communication devices which are in a local device list of a live status, the method further comprises:
transmitting a request to the electro-communication devices;
receiving the live status transmitted from the electro-communication devices; and
updating the live status of the electro-communication devices displayed on the device area.

7. The method for manipulating an electronic device according to claim 1, further comprising:
performing a photographic program to fetch an image;
updating a picture medium file corresponding to the image and designating an address;
receiving a request of the picture medium file form the at least one electro-communication device; and
transmitting the picture medium file to the at least one electro-communication device.

8. The method for manipulating an electronic device according to claim 7, wherein after the at least one electro-communication device receives the picture medium file, the method further comprises:
storing the picture medium file on a local storage area by the at least one electro-communication device;
receiving the picture according to the address when it is determined that the added picture is provided by the electronic device; and
displaying a hint on the device area to explain a transmission result of the picture medium file.

9. The method for manipulating an electronic device according to claim 1, further comprising providing a server contacting the communication module of the electronic device, the method further comprising:
logging in the server by the electronic device, wherein a user account of the electronic device is authenticated by the server;
transmitting an advertisement medium list to the server or receiving the advertisement medium list from the server;
updating the advertisement medium list to a latest status;
receiving an advertisement medium file from the server according to the advertisement medium list; and
playing the advertisement medium file by the touch screen.

10. The method for manipulating an electronic device according to claim 1, further comprising a server contacting the communication module of the electronic device, the method further comprises:
transmitting a device and user behavior information to the server, such that the server adjusts an advertisement weight of the electronic device according to the device and user behavior information, and calculates and stores an overall weight of the electronic device which has been adjusted according to the advertisement weight;
receiving an advertisement medium list from the server;
determining whether the advertisement medium list is the latest;
updating the advertisement medium list if the advertisement medium list is not the latest;
receiving an advertisement medium file according to the updated advertisement medium list; and
playing the advertisement medium file.
